(19) United States
(12) Patent Application Publication
(10) Pub. No.: US 2026/0178829 A1
(43) Pub. Date: Jun. 25, 2026

(54) LLM Log Parsing

(71) Applicant: CrowdStrike, Inc., Sunnyvale, CA (US)

(72) Inventors: James Robert Plush, Coto De Caza, CA (US); Sean Berry, Mission Viejo, CA (US)

(73) Assignee: CrowdStrike, Inc., Sunnyvale, CA (US)

(21) Appl. No.: 18/989,744

(22) Filed: Dec. 20, 2024

(51) Int. Cl. G06F 40/205; G06F 40/40

(52) U.S. Cl. CPC G06F 40/205; G06F 40/40

(57) ABSTRACT

An LLM log parsing service parses log data using at least one large language model. The LLM log parsing service, however, may evaluate multiple log parser candidates. Each log parser candidate parses a sample of the log data using the at least one large language model. The LLM log parsing service generates a log parser decision that selects which one of the log parser candidates best performs as a log parser. The LLM log parsing service then parses the log data using the best log parser.

### BACKGROUND

The subject matter described herein generally relates to computers and, more particularly, the subject matter relates to database structures for information retrieval, to handling natural language data, to data parsing, and to computational learning methods.

Log parsing is difficult. As we use our smartphones, laptops, and other computer systems, software logs document our usage. Indeed, nearly every component in a networked environment generates log data files. These log data files contain detailed information describing internal and external usage events. IT professionals use these log data files to debug code, troubleshoot issues, and investigate security breaches. Before the raw log data files are analyzed, though, the raw log data files are often parsed. Log parsing is the process of converting the raw log data files into a common, machine-readable format. The problem, though, is that log parsing has difficulty keeping up with schema changes. The log data files are generated by many different sources/vendors, and the many different sources/vendors have many different data types and data formats. Moreover, the many different sources/vendors are also always improving and changing their log schemas. Log parsing is thus a very dynamic and challenging environment where parsing errors are common.

### SUMMARY

An LLM log parsing service parses log data using a large language model (or LLM). The LLM log parsing service uses the LLM to translate complicated log data into much more accurate and human understandable natural language statements. The LLM log parsing service, however, may evaluate multiple log parser candidates. Each log parser candidate parses a sample of the log data parsed using the same or different LLM. The LLM log parsing service generates a log parser decision that selects which one of the log parser candidates best performs as a log parser. The LLM log parsing service then parses the log data using the best log parser.

### BRIEF DESCRIPTION OF THE SEVERAL VIEWS OF THE DRAWINGS

The features, aspects, and advantages of LLM log parsing are understood when the following Detailed Description is read with reference to the accompanying drawings, wherein:

FIGS. 1-4 illustrate some examples of an LLM log parsing service;

FIGS. 5-7 illustrate more examples of an LLM log parsing service;

FIGS. 8-10 illustrate some examples of parsing criteria;

FIGS. 11-12 illustrate examples of methods or operations that parse log data;

FIGS. 13-14 illustrate more examples of LLM log parsing;

FIG. 15 illustrates some examples of machine-learned parsing profiling;

FIG. 16 illustrates examples of web interfacing;

FIGS. 17-19 illustrate examples of methods or operations that parse log data; and

FIG. 20 illustrates a more detailed example of an operating environment.

### DETAILED DESCRIPTION

Some examples relate to parsing log data. As we know, diagnosing problems with smartphones, laptops, and other computers is exceptionally difficult. Many software and hardware problems must be resolved by inspecting log data. The log data tracks and records fine details that describe software and hardware operations. When computer problems occur, IT professionals scrutinize the log data to resolve many software and hardware problems. The log data, though, is very complex for many reasons. Because the log data is so complex, many IT professionals parse the log data. Log parsing converts or translates raw log data files into a common, machine-readable format. The common format is usually much easier to understand and use. Log parsing, though, often produces errors. Just like human language translations, sometimes log parsing produces translation errors.

An LLM log parsing service, though, greatly improves the accuracy of log parsing. The LLM log parsing service parses log data using a large language model (or LLM). The LLM uses its natural language processing capabilities to convert the very complicated log data into much simpler textual explanations. The LLM log parsing service thus uses the LLM to translate complicated log data into much more accurate and human understandable natural language statements.

Not all log parsers, though, are created equal. There are many different log parsers, and each log parser may have different performance, cost, and other considerations. Moreover, there are many different large language models, and each large language model may also have different performance, cost, and other considerations. Because there are many different log parsers and LLMs, the LLM log parsing service may evaluate the different log parsers and/or the different LLMs. That is, prior to conducting the actual parsing of the log data, the LLM log parsing service may first generate log parser candidates. Each log parser candidate parses a sample of the log data using a different one of the log parsers. Each one of the log parsers may use the same LLM but have different parsing accuracy/performance. Some or all of the log parsers may use the different LLMs, thus having perhaps even greater parsing accuracy/performance. The LLM log parsing service evaluates the log parser candidates and decides which one of the log parser candidates best performs as a log parser. The LLM log parsing service then parses the log data using the best log parser.

LLM log parsing will now be described more fully hereinafter with reference to the accompanying drawings. LLM log parsing, however, may be embodied in many different forms and should not be construed as limited to the examples set forth herein. These examples are provided so that this disclosure will be thorough and complete and fully convey LLM log parsing to those of ordinary skill in the art. Moreover, all the examples of LLM log parsing are intended to encompass both structural and functional equivalents thereof. Additionally, it is intended that such equivalents include both currently known equivalents as well as equivalents developed in the future (i.e., other elements developed that perform the same function, regardless of structure).

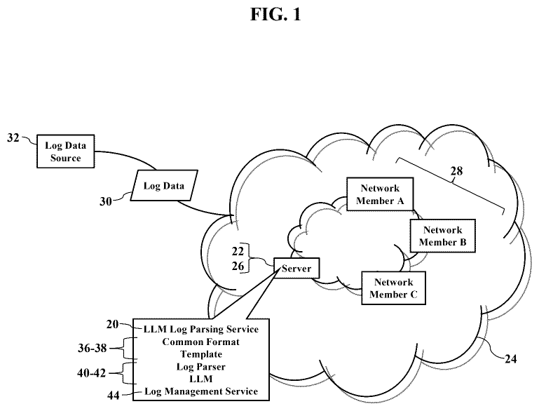

FIGS. 1-4 illustrate some examples of an LLM log parsing service 20. A computer system 22 operates in a cloud computing environment 24. FIG. 1 illustrates the computer system 22 as a server 26. The computer system 22, though, may be another processor-controlled device, as later paragraphs will explain. In this example, the server 26 communicates via the cloud computing environment 24 (e.g., public Internet, private network, and/or hybrid network) with other servers, devices, computers, or other networked members 28 operating within, or affiliated with, the cloud computing environment 24.

As FIG. 1 illustrates, the cloud computing environment 24 provides the LLM log parsing service 20 on behalf of a service provider. The cloud computing environment 24 receives log data 30 from a log data source 32. The cloud computing environment 24 provides the LLM log parsing service 20 and parses the log data 30 into a machine-readable, common format 36 (such as a log template 38). While the networked members 28 may cooperate to provide the digital LLM log parsing service 20, FIG. 1 illustrates a simple example using the server 26. That is, when the cloud computing environment 24 receives the log data 30, the networked members 28 may route, forward, or send the log data 30 to the server 26 for analysis. When the server 26 receives the log data 30, the server 26 ingests the raw log data 30 as inputs and parses the log data 30 using a log parser 40. The log parser 40 is a software application that instructs the server 26 how to convert the log data 30 into the common format 34. The log parser 40, though, parses the log data 30 using a large language model (or LLM) 42.

The LLM log parsing service 20 greatly improves computer functioning. Log parsing is vital to understanding device behavior, software execution, and debugging. Log parsing, though, is exceptionally difficult. The log data 30 is generated by many different applications/devices/sources 32 operating in the field, and the log data 30 has many dynamic variable values that are specific to the applications/devices/sources 32. Because the log data 30 is diverse and complicated, conventional log parsing schemes have low accuracy when converting the log data 30 into the common format 34. The LLM log parsing service 20, though, greatly improves the computer functioning of the server 26 when parsing the log data 30. The LLM log parsing service 20 programs the server 26 to leverage the natural language processing (NLP) provided by the LLM 42 to greatly improve the accuracy of log parsing. Because the LLM 42 is pretrained on a large corpus of text data from diverse sources 32 (such as books, articles, websites, and even source code), the LLM log parsing service 20 applies the LLM 42 to more accurately understand the log data 30. The LLM log parsing service 20 causes the server 26 to greatly improve its computer functioning when log parsing.

The LLM log parsing service 20 may be a component of a log management service 44. The log management service 44 may also be provided on behalf of the service provider. The log management service 44 gathers, stores, processes, synthesizes, and analyzes the log data 30 from the disparate sources 32 (e.g., operating system, applications, servers, users, and endpoints). The log management service 44, for example, may first use the LLM log parsing service 20 to parse the log data 30 (such as one or more files) to extract meaningful information. The LLM log parsing service 20 translates the structured or unstructured log data 30 into the common format 34. The log management service 44 may then allow a user to easily filter, analyze, and manipulate the converted log data 30 (such as key-value information). Perhaps the most common log format is JSON, but the log parser 40 may also interpret other data types (such as like WINDOWS EVENT LOG®, CSV, and W3C).

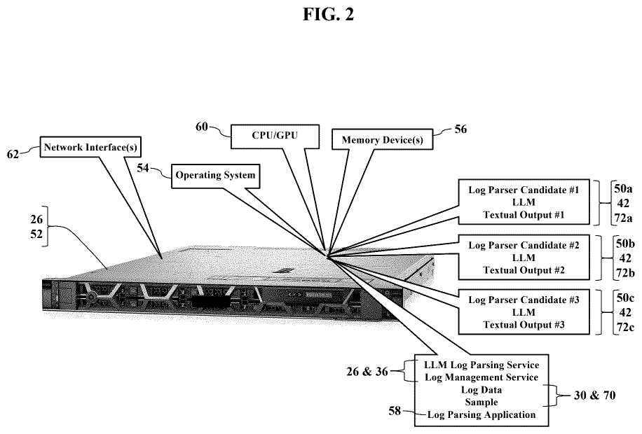

FIG. 2 illustrates log parser candidates 50. Even though the LLM log parsing service 20 leverages the large language model (LLM) 42 to greatly improve the accuracy of the log parser 40, there are many different log parsers 40 and/or many different LLMs 42 that may be used. For example, some log parsers 40 include SigNoz, Fluentd, Graylog, Splunk, Edge Delta, Datalog, Loggly, Logz, and Dynatrace. Some LLMs include OpenAI's CHATGPT®, Meta's open-source LLAMA® models, and Google's PALM® and Google's FLAN®. The LLM log parsing service 20 may thus have a great selection of different log parsers 40 and/or different LLMs 42 from which to choose, and each different log parser 40 and/or LLM 42 may have different performance, accuracy, cost, and other considerations. Because the LLM log parsing service 20 may have access to many different log parsers 40 and/or LLMs 42, the LLM log parsing service 20 may first evaluate the different log parsers 40 and/or LLMs 42 for use in log parsing. That is, prior to conducting the actual parsing of the log data 30, the LLM log parsing service 20 may first generate the log parser candidates 50.

FIG. 2 thus illustrates the log parser candidates 50. FIG. 2 illustrates the server 26 as a rack server 52, which is commonly installed in server rooms and in server farms. The server 26/52 is programmed to generate the log parser candidates 50 using the same, single LLM 42. The server 26/52 stores and executes an operating system 54 in a memory device 56. The server 26/52 also stores a log parser application 58 in the memory device 56. The server 26/52 has a hardware processor with cores 60 (illustrated as “CPU/GPU”) that reads and executes the operating system 54 and the log parser application 58. The server 26/52 also has network interfaces 62 to multiple communications networks (such as the cloud computing environment 24 illustrated in FIG. 1), thus allowing bi-directional communications with other networked devices and services. The log parser application 58 has programming code or instructions that cause the server 26/52 to perform operations, such as generating the log parser candidates 50 using different log parsers 40.

As the server 26/52 provides the services 20 and/or 44, the server 26/52 may first generate the log parser candidates 50. Because the LLM log parsing service 20 may have access to many different log parsers 40, the LLM log parsing service 20 may cause the server 26/52 to generate multiple log parser candidates 50. Each log parser candidate 50 is stored in the memory device 56. In FIG. 2, each log parser candidate 50 uses the same large language model 42 that is available to the LLM log parsing service 20. FIG. 2, for example, illustrates a simple example of three (3) different log parser candidates (illustrated as reference numerals 50a-c), with each log parser candidate 50a-c utilizing the same large language model 42 for log parsing. In actual, real-world practice, though, the LLM log parsing service 20 may choose from tens or even hundreds of different log parsers 40, with each different log parser 40 having different training, configuration, parameters, and many other variables. Such a large number of log parsers 40 is too complicated to illustrate, so FIG. 2 only illustrates the three (3) log parser candidates 50a-c.

The server 26/52 generates the log parser candidates 50a-c. The log parser application 58, for example, instructs the server 26/52 to read/retrieve a sample 70 of the log data 30 to be parsed. The log parser application 58 then instructs the server 26/52 to send or apply the sample 70 of the log data 30 to each different log parser candidate 50a-c utilizing the LLM 42. Each log parser candidate 50a-c interfaces with the LLM 42 to parse the sample 70 of the log data 30. Each log parser candidate 50a-c, for example, may send the sample 70 of the log data 30 via a communications network (such as the public Internet) to a network/IP address associated with the LLM 42. The LLM 42 ingests the sample 70 of the log data 30 as an input and applies its natural language processing capabilities to produce a corresponding textual output 72a-c. Each log parser candidate 50a-c then sends its corresponding textual output 72a-c back to the log parser application 58.

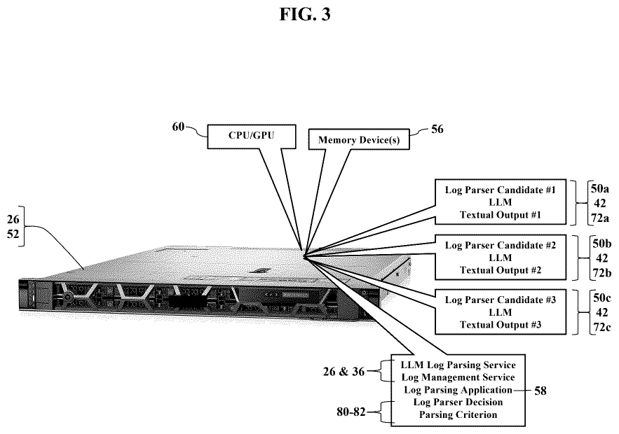

FIG. 3 illustrates candidate evaluation. Once the server 26/52 has generated the multiple log parser candidates 50a-c and received their corresponding LLM-generated textual outputs 72a-c, the server 26/52 may determine which one of the multiple log parser candidates 50a-c is preferred. The log parser application 58, for example, may cause the server 26/52 to evaluate the multiple log parser candidates 50a-c and/or their corresponding LLM-generated textual outputs 72a-c. The log parser application 58 may then generate a log parser decision 80. The log parser decision 80, in simple words, selects the log parser candidate 50 that best suites one or more parsing criteria 82. The parsing criterion/criteria 82 reflects whatever performance, cost, accuracy, or other objectives are desired to determine which one of the multiple log parser candidates 50a-c is preferred.

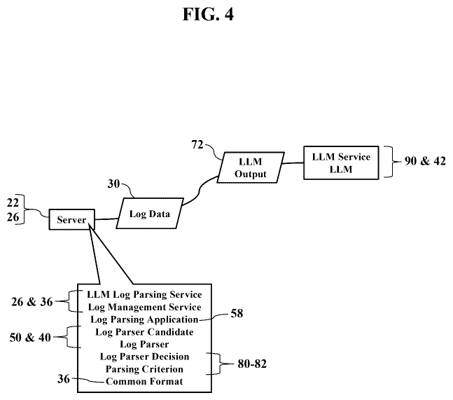

FIG. 4 illustrates parsing of the log data 30. After the server 26 has generated the log parser decision 80, the log data 30 may be parsed. That is, in response to the log parser decision 80, the LLM log parsing service 20 has determined which log parser candidate 50, calling or invoking the large language model 42, best passed/exceeded/satisfied the parsing criteria 82. So, after generating the log parser decision 80, the LLM log parsing service 20 may now proceed with parsing the entirety, or remaining portions, of the log data 30. The log parser application 58, for example, may instruct the server 26 to incorporate the log parser decision 80, and thus the LLM 42, into the log management service 44. The log parser application 58, for example, may instruct the server 26 to designate the log parser candidate 50 as the final, chosen log parser 40. The server 26 thus sends or applies the log data 30 to the log parser 40 that corresponds to the log parser decision 80 (i.e., the winning log parser candidate 50). The server 26, for example, sends the log data 30 via a communications network (such as the public Internet, not shown for simplicity) to the network/IP address that corresponds to a service provider associated with the final, chosen log parser 40. The server 26 may thus outsource the log data 30 to the service provider that parses the log data 30 using the LLM 42. The server 26, however, may additionally or alternatively send the log data 30 via a communications network (again not shown for simplicity) to the network/IP address that corresponds to an LLM service 90 hosting the LLM 42. The LLM 42 ingests the log data 30 as an input, applies its natural language processing, and produces its textual LLM output 72. The LLM service 90 may thus send the LLM output 72 back to the server 26/52, and the log parser application 58 instructs the server 26/52 to generate the common format 34 representing the log data 30 using the final, chosen log parser 40 and the LLM output 72. The LLM log parsing service 20 has thus called or invoked the LLM service 90 to convert the log data 30 into the common format 34.

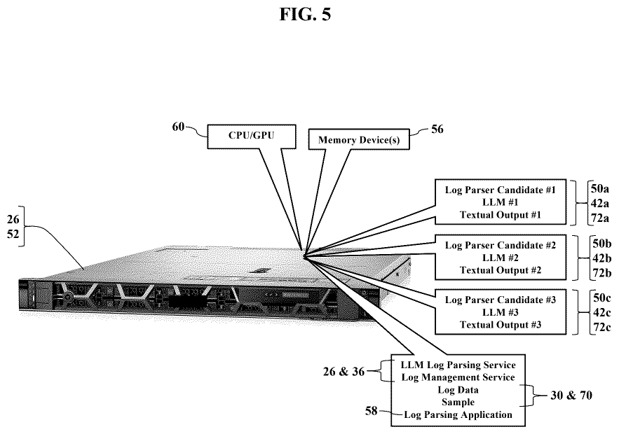

FIGS. 5-7 illustrate more examples of the LLM log parsing service 20. Because the LLM log parsing service 20 may have access to many different log parsers 40 and/or many different large language models 42, the services 20 and/or 44 may evaluate the different log parsers 40 and/or the different LLMs 42 for use in log parsing. In FIG. 5, for example, the server 26/52 generates the multiple log parser candidates 50, but one or more of the log parser candidates 50 may utilize different large language models 42. Again, in actual practice, the LLM log parsing service 20 may choose from tens or even hundreds of different log parsers 40 and/or many different LLMs 42. Such a large number of log parser candidates 50 is too complicated to illustrate, so FIG. 5 again simply illustrates the three (3) log parser candidates 50a-c. Each log parser candidate 50a-c, though, is illustrated as utilizing a corresponding one of the different large language models 42a-c.

The server 26/52 generates the log parser candidates 50a-c. The log parser application 58, for example, instructs the server 26/52 to read/retrieve the sample 70 of the log data 30 to be parsed. The log parser application 58 then instructs the server 26/52 to send or apply the sample 70 of the log data 30 to each different log parser candidate 50a-c utilizing its corresponding LLM 42a-c. Some of the log parser candidates 50, for example, may utilize the same LLM 42. One or more of the log parser candidates 50, though, may utilize different LLMs 42. Again, there may be a great variety of parsers/models 40/42 available to the server 26/52 for evaluation. In general, then, each log parser candidate 50a-c interfaces with its corresponding LLM 42a-c to parse the sample 70 of the log data 30. Each log parser candidate 50a-c, for example, may send the sample 70 of the log data 30 via a communications network (such as the public Internet) to a network/IP address associated with its corresponding LLM 42a-c. Each LLM 42a-c ingests the sample 70 of the log data 30 as an input and applies its natural language processing capabilities to produce a corresponding textual output 72a-c. Each log parser candidate 50a-c then sends its corresponding output 72a-c back to the log parser application 58.

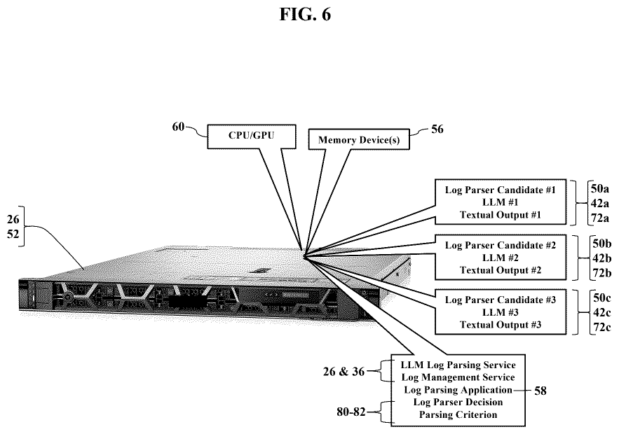

FIG. 6 illustrates candidate evaluation. Once the server 26/52 has generated the multiple log parser candidates 50a-c and received their corresponding LLM-generated textual outputs 72a-c, the server 26/52 may determine which one of the multiple log parser candidates 50a-c is preferred. The log parser application 58, for example, may cause the server 26/52 to evaluate the multiple log parser candidates 50a-c and/or their corresponding LLM-generated textual outputs 72a-c. The log parser application 58 may then generate the log parser decision 80. The log parser decision 80, in simple words, selects the log parser candidate 50 that best suites one or more parsing criteria 82. The parsing criterion/criteria 82 reflects whatever performance, cost, accuracy, or other objectives are desired to determine which one of the multiple log parser candidates 50a-c is preferred.

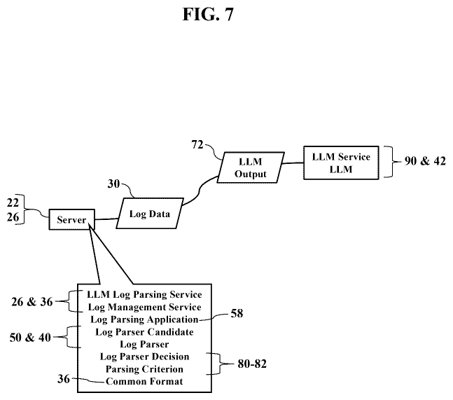

FIG. 7 illustrates parsing of the log data 30. After the server 26 has generated the log parser decision 80, the log data 30 may be parsed. That is, in response to the log parser decision 80, the LLM log parsing service 20 has determined which log parser candidate 50, and thus which corresponding large language model 42, best passed/exceeded/satisfied the parsing criteria 82. So, after generating the log parser decision 80, the LLM log parsing service 20 may now proceed with parsing the entirety, or remaining portions, of the log data 30. The log parser application 58, for example, may instruct the server 26 to incorporate the log parser decision 80, and thus the associated LLM 42, into the log management service 44. The log parser application 58, for example, may instruct the server 26 to designate the log parser candidate 50 as the final, chosen log parser 40. The server 26 thus sends or applies the log data 30 to the log parser 40 that corresponds to the log parser decision 80 (i.e., the winning log parser candidate 50). The server 26, for example, sends the log data 30 via a communications network (such as the public Internet, not shown for simplicity) to the network/IP address that corresponds to the service provider associated with the final, chosen log parser 40. The server 26 may thus outsource the log data 30 to the service provider that parses the log data 30 using the corresponding LLM 42. The server 26, however, may additionally or alternatively send the log data 30 via a communications network (again not shown for simplicity) to the network/IP address that corresponds to the LLM service 90 hosting the LLM 42. The winning/selected/chosen log parser 40 and/or LLM 42 ingests the log data 30 as an input, applies natural language processing, and produces its textual LLM output 72. The parsing service provider and/or the LLM service 90 sends its service result back to the server 26/52, and the log parser application 58 instructs the server 26/52 to generate the common format 34 representing the log data 30 using the LLM output 72. The LLM log parsing service 20 has thus called or invoked the log parser 40 and/or LLM 42 to convert the log data 30 into the common format 34.

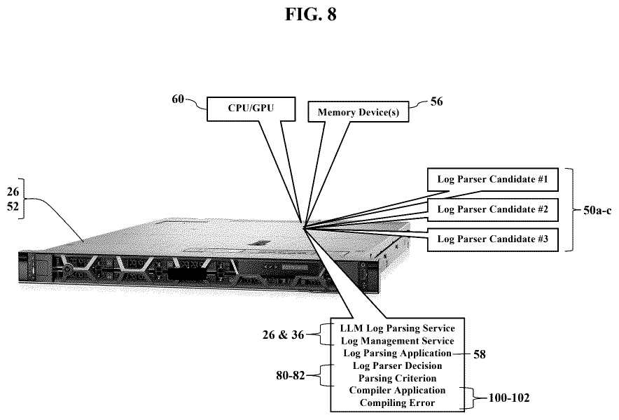

FIGS. 8-10 illustrate some examples of the parsing criteria 82. Once the server 26 (again illustrated as the rack server 52) has generated the multiple log parser candidates 50a-c (using one or difference large language models 42, as explained with reference to FIGS. 1-7), the server 26/52 may determine which one of the multiple log parser candidates 50a-c is preferred. FIG. 8, for example, illustrates compiling as the parsing criteria 82. The LLM log parsing service 20 may apply a compiler application 100 to each log parser candidate 50a-c. Each log parser candidate 50a-c may provide its source code as an input to the compiler application 100, and the compiler application 100 translates the source code into executable instructions. If the log parser candidate 50 successfully compiles, then the LLM log parsing service 20 may keep the log parser candidate 50 as a parsing contender. That is, because the log parser candidate 50 successfully compiled, the log parser candidate 50 may remain an eligible candidate for the log parser decision 80. If, however, the log parser candidate 50 fails to compile, then the log parser candidate 50 contains or represents a compiling error 102. The LLM log parsing service 20 may remove or reject the log parser candidate 50 as a parsing contender and may eliminate the log parser candidate 50 from eligibility for the log parser decision 80.

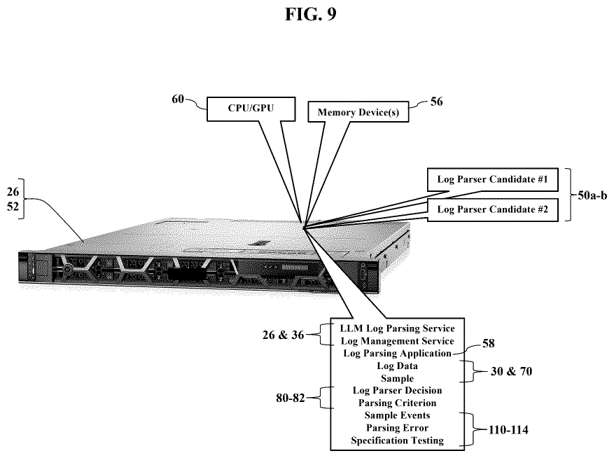

FIG. 9 illustrates event generation. The LLM log parsing service 20 may determine which one or more of the log parser candidates 50 remain after compiling (as explained with reference to FIG. 8). Suppose, for example, that only log parser candidates 50a-b remain eligible for the log parser decision 80. Once the remaining log parsing contenders are determined, the LLM log parsing service 20 may then generate sample events 110 using the log parsing contenders. The log parser application 58, for example, may instruct the server 26 (again illustrated as the rack server 52) to generate one, or many, sample events 110 using each log parser candidate 50a-b that successfully compiled. The server 26/52 may thus parse the sample 70 of the log data 30 using each log parser candidate 50a-b that successfully compiled. When the server 26/52 log parses the sample 70 of the log data 30 using each log parser candidate 50b-c, the server 26/52 may generate a corresponding collection of the sample events 110a-b. Each collection of the sample events 110a-b describes an action or occurrence described by the sample 70 of the log data 30, albeit using the different log parser candidate 50a-b. Each sample event 110, for example, may describe a date/time stamp, event description, severity, application/process/OS, identifying code(s), IP address, username, and other event information. Whatever the event information, the server 26/52 may generate different sample events 110 using each log parser candidate 50 that successfully compiled.

Parsing errors 112 may winnow the log parser candidates 50. When the server 26/52 log parses the sample 70 of the log data 30 using each log parser candidate 50, the server 26/52 may generate different collections of the sample events 110 associated with each log parser candidate 50. If the sample events 110, generated using the corresponding log parser candidate 50, exhibit no parsing error 112, then the LLM log parsing service 20 may keep the log parser candidate 50 as a parsing contender. Because the log parser candidate's sample events 110 successfully parsed, the log parser candidate 50 may remain an eligible candidate for the log parser decision 80. If, however, the log parser candidate's sample events 110 exhibit the parsing error 112, then the LLM log parsing service 20 may remove the log parser candidate 50 as a parsing contender. The LLM log parsing service 20 may thus eliminate the log parser candidate 50 from eligibility for the log parser decision 80.

The LLM log parsing service 20 may generate the log parser decision 80. The log parser application 58, for example, may instruct the server 26/52 to evaluate the log parser candidates 50 that successfully compiled and/or that lacked parsing errors 112. If only a single log parser candidate 50 remains viable/eligible for the log parser decision 80, then the log parser decision 80 may select or reflect that parsing winner. If, however, more than one log parser candidate 50 remains viable/eligible for the log parser decision 80, then the LLM log parsing service 20 may implement additional testing/evaluation schemes. For example, the log parser candidates 50 that remain eligible for the log parser decision 80 may be subjected to specification testing 114. The LLM log parsing service 20 may have specific rules, tests, objectives, standards, and other requirements that must be satisfied. The log parser application 58 may thus instruct the server 26/52 to evaluate the eligible log parser candidates 50 according to the specification testing 114. The specification testing 114 may thus have several or many selection requirements that narrow down the eligible log parser candidates 50 to the single log parser candidate 50.

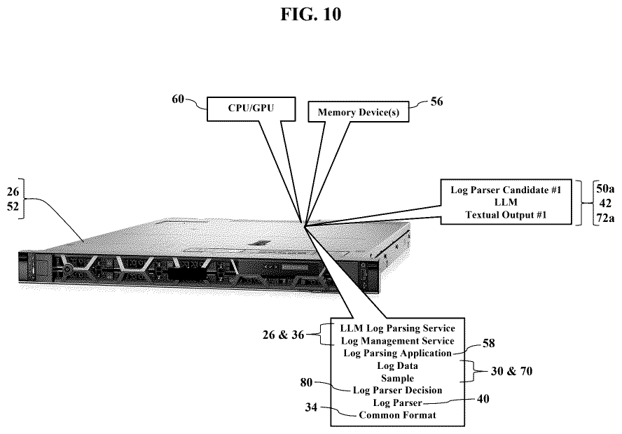

As FIG. 10 illustrates, the log data 30 may then be parsed. Once the log parser decision 80 is generated, the LLM log parsing service 20 has determined which log parser candidate (such as 50a), and thus which corresponding large language model 42, best parsed the sample 70 of the log data 30. The log parser application 58 may then instruct the server 26/52 to designate or assign the log parser candidate 50a as the log parser 40. The LLM log parsing service 20, and/or the log management service 44, may then commence parsing the entirety, or remaining portions, of the log data 30. The log parser application 58, for example, may instruct the server 26/52 to incorporate the log parser decision 80, and thus the associated log parser 40 and/or LLM 42, into the log management service 44. The log parser application 58, for example, may instruct the server 26/52 to send or apply the log data 30 to the log parser 40 and/or the LLM 42 that corresponds to the log parser decision 80 (i.e., the winning log parser candidate 50a). The server 26/52, for example, sends the log data 30 to the network/IP address that corresponds to the service provider, log parser 40, and/or LLM service 90 associated with the log parser decision 80 (as explained and illustrated with reference to FIGS. 1-7). The server 26/52 receives the service result (such as the textual LLM output 72) as a service response. The log parser application 58 instructs the server 26/52 to generate the common format 34 representing the log data 30 using the service result. The LLM log parsing service 20 has thus called or invoked the winning/chosen log parser 40 and/or the LLM 42 to convert the log data 30 into the common format 34.

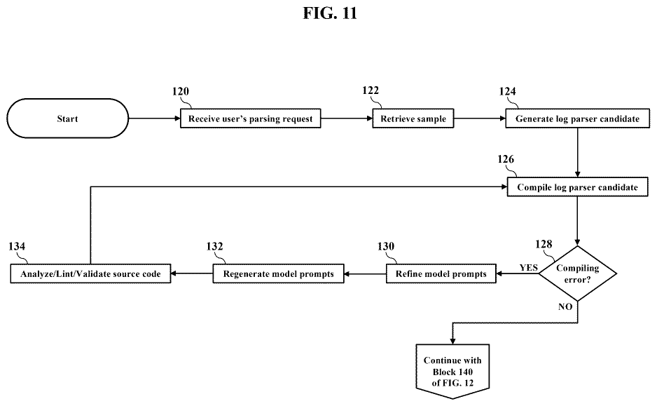

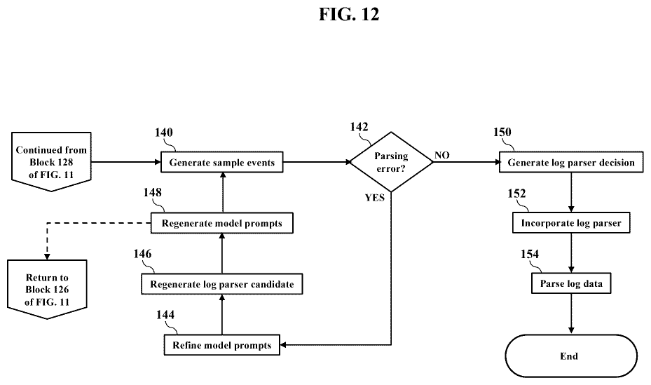

FIGS. 11-12 illustrate more examples of methods or operations that parse the log data 30. FIG. 11, for example, illustrates prompt refinements to the large language model 42. A user of the log management service 44, for example, requests that the log data 30 be parsed (Block 120). The server 26/52 providing the cloud-based, digital log management service 44 may retrieve the sample 70 of the log data 30 (Block 122) and generate the log parser candidate 50 associated with the LLM 42 (Block 124). The server 26/52 evaluates the multiple log parser candidates 50, such as by compiling each log parser candidate 50 (Block 126). If the log parser candidate 50 fails to compile (Block 128), then the compiling error 102 may be used to refine the input model prompts associated with the corresponding large language model 42 (Block 130). The compiling error 102 may thus be used as feedback to adjust the input prompts (such as queries, instructions, and/or questions) and to prime or guide the LLM 42 for log parsing tasks. The model prompts may thus be regenerated (Block 132) and the source code may be analyzed/linted for errors and validated (Block 134). Once the large language model 42 is so refined, the log parser candidate 50 may be again or re-compiled (Block 126).

The examples continue with FIG. 12. When the log parser candidate 50 successfully compiles (see Block 128 of FIG. 11), then the log parser candidate 50 remains eligible as a final log parser 40. The server 26/52 may generate the sample events 110 using the log parser candidate 50 (Block 140). If one or more of the sample events 110 contain, represent, and/or are associated with the parsing error 112 (Block 142), then the parsing error 112 may be used to refine the input model prompts associated with the corresponding large language model 42 (Block 144). The log parser candidate 50 may be regenerated (Block 144) and the model prompts may thus be regenerated (Block 146). Once the large language model 42 is so refined, the log parser candidate 50 may again be used to regenerate the sample events 110 (Block 148). Optionally, though, the refined log parser candidate 50 may be re-compiled and checked for the compiling error 102 (see Blocks 126 & 128 of FIG. 11).

Once the error-free sample events 110 are determined (Block 142), the server 26 generates the log parser decision 80 (Block 150). The log parser decision 80 selects the final log parser from among the log parser candidates 50. The server 26 then incorporates and/or imports the winning log parser 40 into the LLM log parsing service 20 and/or the log management service 44 (Block 152). The server 26 then log parses the log data 30 (from which the sample 70 was collected) using the final log parser 40 and its corresponding LLM 42 (Block 154).

The LLM log parsing service 20, and/or the log management service 44, may thus be self-healing processes. As FIGS. 11-12 illustrate, the compiling error 102 may be used to heal, resolve, and improve compiling of the log parser candidate 50. Indeed, the compiling error 102 may be used to upgrade/downgrade the corresponding LLM 42 and, thus, affect eligibility as the final log parser. Moreover, the compiling error 102 may be deterministically applied to the linting and validation of the source code, thus again further improving compiling results. As FIGS. 11-12 also illustrate, the parsing error 112 may also be used to heal, resolve, and improve event generation. The parsing error 112 may be used to upgrade/downgrade the corresponding LLM 42 and, thus, affect eligibility as the final log parser 40.

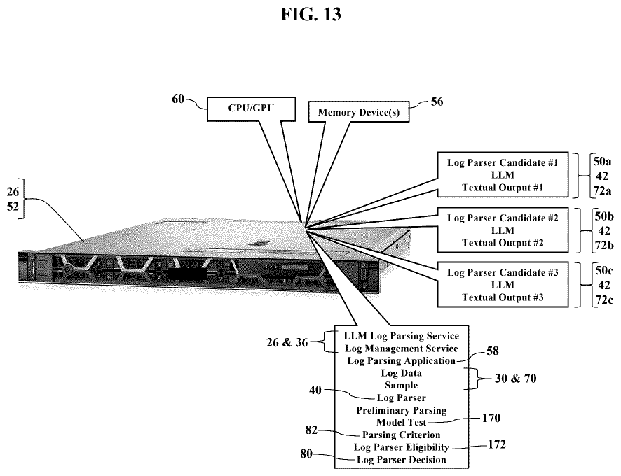

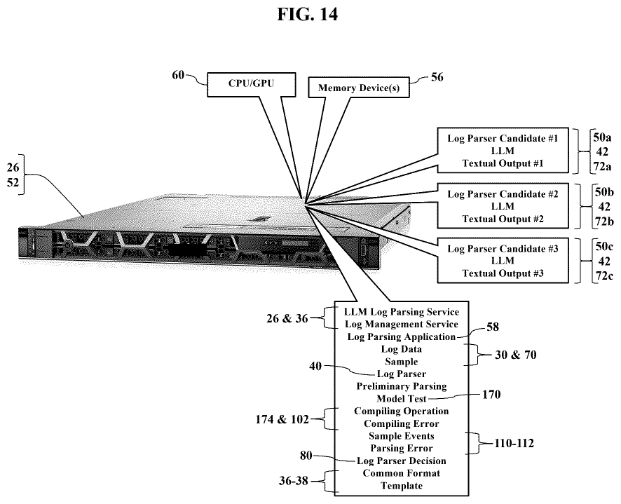

FIGS. 13-14 illustrate more examples of LLM log parsing. Here the server 26 (again illustrated as the rack server 26) conducts one or more preliminary parsing model tests 170 prior to log parsing the log data 30. When the LLM log parsing service 20, and/or the log management service 44, is requested (such as by a user, as later paragraphs will explain), the log parser application 58 instructs the server 26/52 to sample the log data 30 (thus generating the sample 70). The log parser application 58 instructs the server 26/52 to generate the log parser candidates 50 associated with the same or different LLM 42. FIG. 13, for simplicity, merely illustrates the three (3) different log parser candidates 50a-c. Again, though, in actual, real-world practice, the services 20/44 may choose from many different log parsers 40 and/or LLMs 42. Each log parser candidate 50 thus represents the sample 70 of the log data 30 parsed using a different one of the log parsers 40 and/or LLMs 42. The log parser application 58 instructs the server 26/52 to conduct the preliminary parsing model test(s) 170 that compare(s) the multiple log parser candidates 50 to at least one parsing criterion 82. The preliminary parsing model test(s) 170 determines a log parser eligibility 172 for each log parser candidate 50. If the log parser candidate 50 passes or satisfies the preliminary parsing model test(s) 170, then the log parser candidate 50 is eligible to be chosen as the log parser 40. If, however, the log parser candidate 50 fails to pass or satisfy the preliminary parsing model test(s) 170, then the log parser candidate 50 may be ineligible as the log parser 40 and ineligible for the log parser decision 80.

FIG. 14 illustrates examples of the preliminary parsing model test 170. The preliminary parsing model test 170, for example, may include calling or invoking a compiling operation 174 that compiles each log parser candidate 50a-c (such as explained with reference to FIGS. 1-7). If the compiling error 102 is generated or returned, for example, then perhaps the log parser candidate 50 may be rejected as the winning log parser 40. The log parser candidate 50 may thus be ineligible for the log parser decision 80. If, however, the log parser candidate 50 successfully compiles, then the preliminary parsing model test 170 may continue. The log parser application 58, for example, may instruct the server 26/52 to generate the sample event(s) 110 by parsing the sample 70 of the log data 30 using the log parser candidate 50 that successfully compiled. As more examples, if the sample event 110 is associated with the parsing error 112, then perhaps the log parser application 58 instructs the server 26/52 to reject the log parser candidate 50 as the log parser 40. That is, the log parser candidate 50 may be ineligible for the log parser decision 80. If, however, the sample event 110 successfully parses to the common format 34 (such as a valid or recognized template 38), then the log parser application 58 may instruct the server 26/52 to approve the log parser candidate 50 as eligible for the log parser decision 80. The log parser candidate 50 thus remains a candidate as the final log parser 40 based on the error-free sample event 110.

Once the eligible log parser candidates 50 are identified, the log parser decision 80 is generated. The log parser application 58 instructs the server 26/52 to select the final log parser 40 that will be used to parse the remaining log data 30. If only a single log parser candidate 50 remains eligible for the log parser decision 80, then the server 26/52 selects the only eligible log parser candidate 50 as the parsing winner. If, however, more than one log parser candidate 50 remains eligible for the log parser decision 80, then the LLM log parsing service 20 may implement additional evaluations. For example, the eligible log parser candidates 50 may be subjected to the specification testing 114 (as illustrated and explained with reference to FIG. 9). The LLM log parsing service 20 may have specific rules, tests, objectives, standards, and other requirements that must be satisfied. The log parser application 58 may thus instruct the server 26/52 to evaluate the eligible log parser candidates 50 according to the specification testing 114. The specification testing 114 may thus have several or many selection requirements that narrow down the eligible log parser candidates 50 to the single log parser candidate 50. Once the log parser decision 80 renders the final log parser 40, then, in response to the log parser decision 80, the log parser application 58 instructs the server 26/52 to parse the log data 30 using the final log parser 40. The LLM log parsing service 20, and/or the log management service 44, parses the log data 30 using the LLM 42 associated with the final log parser 40.

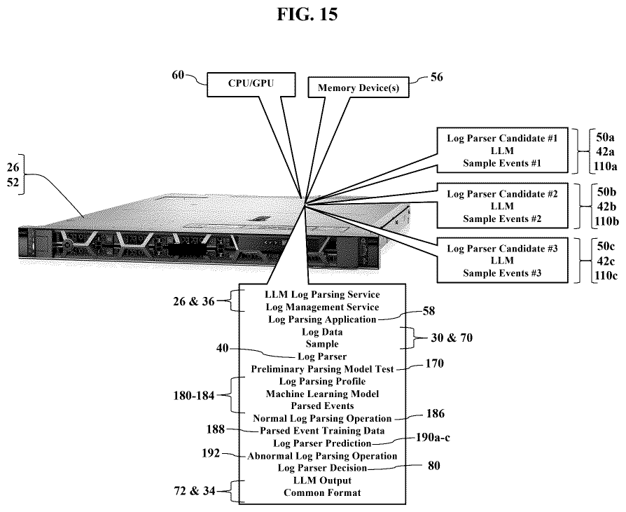

FIG. 15 illustrates some examples of machine-learned parsing profiling. The LLM log parsing service 20, and/or the log management service 44, may use additional artificial intelligence and/or machine learning to determine the best log parser candidate 50 for log parsing the log data 30. The log parser application 58, for example, may instruct the server 26 (again illustrated as the rack server 26) to generate the sample 70 by sampling the log data 30. The log parser application 58 also instructs the server 26/52 to generate the log parser candidates (illustrated as 50a-c) associated with the same or different LLM(s) 42. Again, because the services 20/44 may select from different log parsers 40 and/or different large language models 42, each log parser candidate 50 represents the sample 70 of the log data 30 parsed using a different one of the parsers/models 40/42. The log parser application 58 may instruct the server 26/52 to conduct the preliminary parsing model test(s) 170 that winnow out, reject, or otherwise remove ineligible candidates (such as by compiling, as previously explained). The log parser application 58 may instruct the server 26/52 to generate the sample events (110a-c) by parsing the sample 70 of the log data 30 using each log parser candidate 50a-c. Parsing errors 112 may further winnow out, reject, or otherwise remove ineligible candidates (as previously explained with reference to FIGS. 9, 11-12 & 14). The server 26/52 may thus evaluate different collections of the sample events 110a-c that remain after conducting the preliminary parsing model test(s) 170.

Once the sample events 110a-c are identified, profiling may commence. The log parser application 58, for example, may instruct the server 26/52 to compare the sample events 110a-c to a log parsing profile 180. The log parsing profile 180 is generated by a machine learning model 182 that is trained to represent parsed events 184. That is, the machine learning model 182 is trained with data that represents successfully, and/or unsuccessfully, parsed events 184. The log parsing profile 180, as examples, may represent, statistically define, and/or specify the common formats 36, the templates 38, operating system events, software/process events, and/or other information associated with successful, and/or unsuccessful, historical log parsing. The log parsing profile 180, as examples, may describe the templates 38 and/or events that have been historically parsed and passed/satisfied the rules, tests, objectives, standards, and other specification testing 114 (as illustrated and explained with reference to FIG. 9). The log parsing profile 180, in other words, may describe the templates 38 and/or the parsed events 184 that have been prioritized, categorized, assessed, and/or analyzed as valid, acceptable, and/or normal log parsing operation 186. The log parsing profile 180 may thus represent current and/or historical information, data, event codes, event descriptions, bits/bytes, and/or other electronic content that is/are known to indicate normal log parsing operation 186. Whatever information or data is represented by the sample event 110, for example, that information or data may be compared to the log parsing profile 180. If the electronic content represented by the sample event 110 equals, matches, satisfies, lies within, or conforms to the log parsing profile 180, then the log parser application 58 may determine the corresponding sample event 110 represents the safe/normal log parsing operation 186.

The services 20/44 may thus profile the sample events 110a-c generated using each log parser candidate 50a-c. Each different collection of the sample events 110a-c, generated by parsing the sample 70 using a different one of the log parser candidates 50a-c, may be compared to the log parsing profile 180. As a simple example, the machine learning model 182 may generate the log parsing profile 180 using Gaussian probability distributions based on parsed event training data 188 derived from historical and/or current parsed events 184. One or more standard deviations and confidence intervals may then be calculated to predict ranges of the safe/normal log parsing operation 186. As the log parser application 58 inspects the sample event(s) 110, statistical models representing the log parsing profile 180 may be used to predict that the sample event(s) 110 lies within, or deviates or differs from, the log parsing profile 180.

The services 20/44 may thus predict successful and unsuccessful log parsing. The services 20/44 may thus invoke profiling and prediction associated with the sample events 110a-c generated using each log parser candidate 50a-c. The log parser application 58, for example, may instruct the server 26/52 to generate a log parser prediction 190a-c associated with each log parser candidate 50a-c. When the server 26/52 compares the sample events 110a-c to the log parsing profile 180, the log parser application 58 may instruct the server 26/52 to predict whether the content represented by one or more of the sample events 110a-c statistically lies within, or conforms to, the log parsing profile 180. If, for example, an entire collection of the sample events 110a (associated with the corresponding log parser candidate 50a) statistically lies within, or conforms to, the log parsing profile 180, then the server 26/52 may generate the log parser prediction 190a as the safe/normal log parsing operations 186. If, however, none of the sample events (such as 110b associated with the corresponding log parser candidate 50b and the corresponding LLM 42b) statistically lie within, or conform to, the log parsing profile 180, then the server 26/52 may categorize the sample events 110b as abnormal log parsing operations 192. Simply put, if the sample events 110b fail to conform to the log parsing profile 180, then the server 26/52 may generate the log parser prediction 190b as abnormal log parsing operations 192. As another example, if only 75% the sample events 110 conform to the log parsing profile 180, then the log parser application 58 may be configured still predict safe/normal log parsing operations 186. Indeed, the log parser application 58 may be configured with one or more log parsing threshold values that numerically specify min/max or other requirements for the sample events 110 to be predicted as safe/normal log parsing operations 186 or as abnormal log parsing operations 192.

The services 20/44 may select the best LLM-based log parser 40. The server 26/52 has generated the log parser prediction 190a-c associated with each log parser candidate 50a-c. Each log parser prediction 190a-c statistically reflects how much, or how little, the corresponding sample events 110a-c conform to the log parsing profile 180. The log parser application 58 may instruct the server 26/52 to compare the different log parser predictions 190a-c and to generate the log parser decision 80. The server 26, for example, selects the log parser 40 from the multiple log parser candidates 50a-c, based on the different log parser predictions 190a-c. The log parser application 58, for example, may instruct the server 26/52 to compare numerical values represent the different log parser predictions 190a-c. The server 26/52, for example, may select the log parser prediction 190 having the largest/greatest numerical value, smallest/tightest ±3σ range, highest ranking, or other threshold value(s). The server 26/52, as more examples, may generate the log parser decision 80 to reflect or represent the log parser candidate 50 having the best/most sample events 110 that conform to the log parsing profile 180. Indeed, the log parser application 58 may be configured with one or more selection schemes or mechanisms that favors, or disfavors, the log parser candidates 50. The log parser application 58, in general, may instruct the server 26/52 to generate the log parser decision 80 that represents which one of the log parser candidates 50 best performs as the log parser 40.

The services 20/44 may parse the log data 30. Once the log parser decision 80 is generated, the services 20/44 have determined which log parser candidate 50 (and thus perhaps which corresponding large language model 42), best parsed the sample 70 of the log data 30. The LLM log parsing service 20, and/or the log management service 44, may then commence parsing the entirety, or remaining portions, of the log data 30. The log parser application 58, for example, may instruct the server 26/52 to incorporate the log parser decision 80, and thus the associated parser/model 40/42, into the log management service 44. The log parser application 58, for example, may instruct the server 26/52 to outsource the log data 30 to the parser/model 40/42 that corresponds to the log parser decision 80 (i.e., the winning log parser candidate 50 selected from the multiple log parser candidates 50). The server 26/52, for example, sends the log data 30 to the service provider associated with the parser/model 40/42 (such as the LLM service 90 hosting the LLM 42, as explained and illustrated with reference to FIGS. 4 & 7). The server 26 may then receive the service result (such as the textual LLM output 72). The server 26/52 may then generate the common format 34 representing the parsing of the log data 30 using the parser/model 40/42.

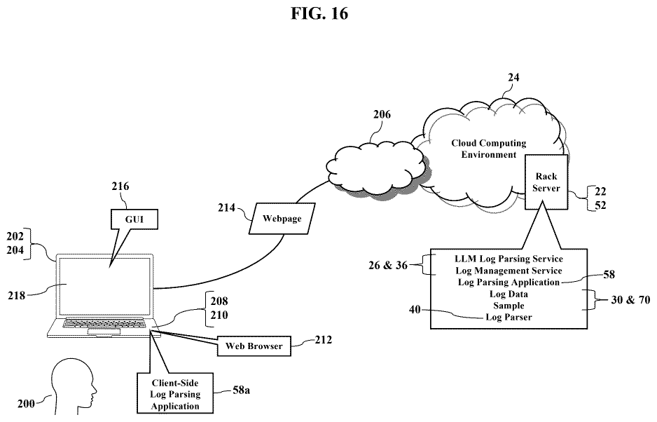

FIG. 16 illustrates examples of web interfacing. The LLM log parsing service 20, and/or the log management service 44, may have a user/web interface that allows user interaction and feedback. FIG. 63 thus illustrates remote access to the services 20 and/or 44. A human user 200 (such as an IT professional), for example, may use a computer 202 to interface with the computer system 22 (again illustrated as the rack server 52). FIG. 16 illustrates the computer 202 as a remote laptop computer 204, but the computer 202 may be a smartphone, tablet, server, or other computer system. The computer 202 has a network interface to an access network or other communications network 206 (such as the public Internet), thus allowing the computer 202 to establish network communications with the cloud computing environment 24 and/or with the rack server 52. The computer 202 may thus have access permissions to the cloud computing environment 24 and/or to the rack server 52. The computer 202 has a hardware processor 208 that executes a client-side version 58a of the log parsing application 58 stored in a memory device 210. The log parsing application 58 and the client-side version 58a may cooperate in a client-server relationship to facilitate a human review and analysis of the log data 30.

The user's computer 202 stores and executes a web browser 212 that interfaces with the client-side version 58a of the log parsing application. When the human user 200 wishes to review/analyze/search the log data 30, the human user 200 commands the client-side version 58a of the log parsing application to establish communication with the rack server 52. The web browser 212 and the client-side version 58a cooperate to request and to receive a webpage 214 having content representing, for example, the log data 30. The user's computer 202 processes and displays the webpage 214 as a dashboard or other graphical user interface (GUI) 216 via a display device 218. The human user 200 may thus scrutinize the log data 30 and request log parsing. The human user 200 may make graphical/tactile/capacitive inputs that request the LLM-based log parsing of the log data 30. The user's computer 202 sends a log parsing request (not shown for simplicity) to a network/IP address associated with the cloud computing environment 24 and/or with the rack server 52. When the rack server 52 receives the log parsing request, the log parsing application 58 instructs the rack server 52 to execute the LLM log parsing service 20, and/or the log management service 44. The rack server 52 thus determines which one of the log parser candidates 50 best performs as the log parser 40 (as this disclosure previously explained). The rack server 52 then parses, or coordinates parsing, the log data 30 using the chosen log parser 40.

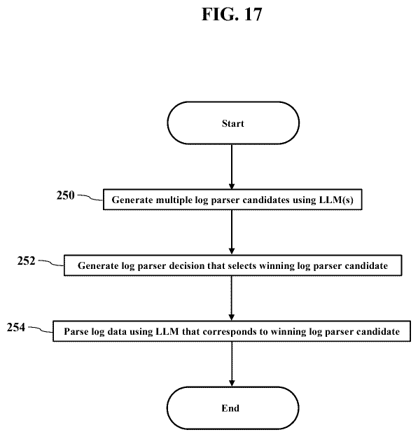

FIG. 17 illustrates examples of a method or operations that parse the log data 30. The computer system 22, providing at least a portion of the LLM log parsing service 20 and/or the log management service 44, generates the multiple log parser candidates 50 using the same or different large language model(s) 42 (Block 250). Each log parser candidate 50 represents the sample 70 of the log data 30 parsed using the corresponding large language model 42 (perhaps of the different large language models 42a-c). The computer system 22 generates the log parser decision 80 that selects the winning log parser candidate 50 of the multiple log parser candidates 50 (Block 252). The computer system 22, in response to the log parser decision 80, parses the log data 30 using the large language model 42 that corresponds to the winning log parser candidate 50 selected from the multiple log parser candidates 50 (Block 254).

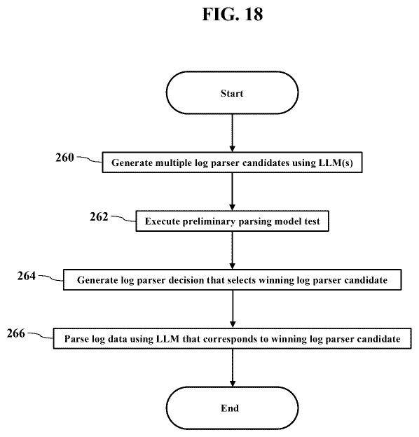

FIG. 18 illustrates examples of more methods or operations that parse the log data 30. The computer system 22, providing at least a portion of the LLM log parsing service 20 and/or the log management service 44, generates the multiple log parser candidates 50 using the same or different large language model(s) 42 (Block 260). Each log parser candidate 50 represents the sample 70 of the log data 30 parsed using the corresponding large language model 42. The computer system 22 executes the preliminary parsing model test 170 that compares the multiple log parser candidates 50 to at least one parsing criterion 82 (Block 262). The computer system 22 generates the log parser decision 80 that selects the log parser candidate 50 from the multiple log parser candidates 50 based on the preliminary parsing model test 170 (Block 264). The computer system 22, in response to the log parser decision 80, parses the log data 30 using the large language model 42 that corresponds to the winning log parser candidate 50 selected from the multiple log parser candidates 50 (Block 266).

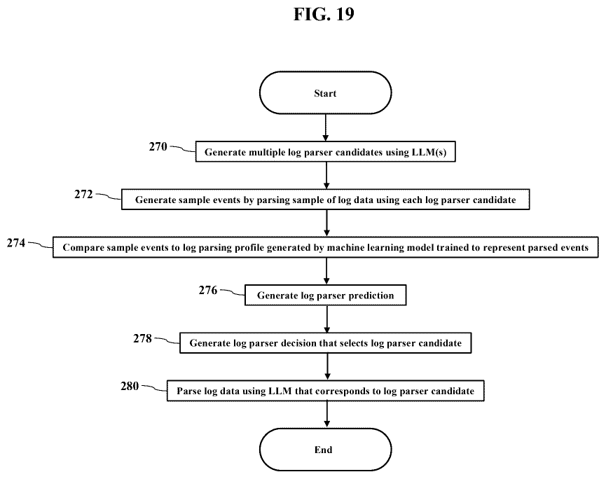

FIG. 19 illustrates examples of still more methods or operations that parse the log data 30. The computer system 22, providing at least a portion of the LLM log parsing service 20 and/or the log management service 44, generates the multiple log parser candidates 50 using the same, or different, large language model(s) 42 (Block 270). Each log parser candidate 50 represents the sample 70 of the log data 30 parsed using the corresponding large language model 42. The computer system 22 generates the sample events 110 by parsing the sample 70 of the log data 30 using each log parser candidate 50 (Block 272). The computer system 22 compares the sample events 110 to the log parsing profile 180 generated by the machine learning model 182 trained to represent the parsed events 184 (Block 274). The computer system 22 generates the log parser predictions 190 (Block 276) and generates the log parser decision 80 that selects a log parser candidate 50 based on the log parser predictions 190 (Block 278). The computer system 22, in response to the log parser decision 80, parses the log data 30 using the large language model 42 associated with the log parser candidate 50 (Block 280).

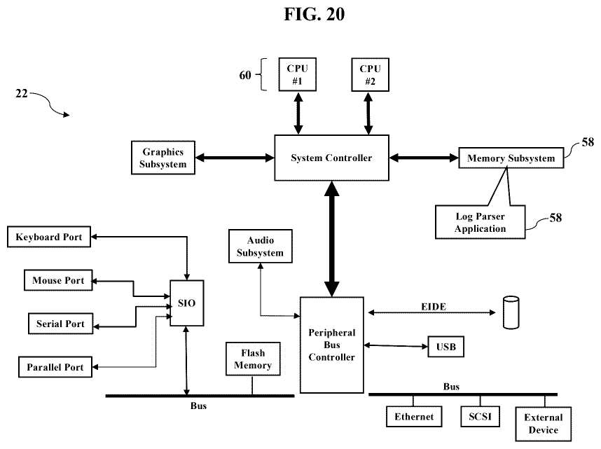

FIG. 20 illustrates more detailed examples of the operating environment. FIG. 20 is a more detailed block diagram illustrating the computer system 22. The log parser application 58 is stored in the memory subsystem or device 56. One or more of the hardware processors 60 communicate with the memory subsystem or device 56 and execute the log parser application 58. Examples of the memory subsystem or device 56 may include Dual In-Line Memory Modules (DIMMs), Dynamic Random Access Memory (DRAM) DIMMs, Static Random Access Memory (SRAM) DIMMs, non-volatile DIMMs (NV-DIMMs), storage class memory devices, Read-Only Memory (ROM) devices, compact disks, solid-state, and other read/write memory technology. Because the computer system 22 is known to those of ordinary skill in the art, no detailed explanation is needed.

The computer system 22 may have other embodiments. This disclosure mostly discusses the computer system 22 as the server 22/56. The LLM log parsing service 20 and/or the log management service 44, however, may be easily adapted to other stationary or mobile computing examples, such as a desktop computer, a tablet computer, a smartwatch, and a network switch/router. The services 20/44 may also be easily adapted to other embodiments of smart devices, such as a television, an audio device, a remote control, and a recorder. The services 20/44 may also be easily adapted to still more smart appliances, such as washers, dryers, and refrigerators. Indeed, as cars, trucks, and other vehicles grow in electronic usage and in processing power, the services 20/44 may be easily incorporated into a vehicular controller.

The above examples of the services 20/44 may be applied regardless of the networking environment. The services 20/44 may be easily adapted to stationary or mobile devices having wide-area networking (e.g., 4G/LTE/5G/6G/7G cellular), wireless local area networking (WI-FI®), near field, and/or BLUETOOTH® capability. The services 20/44 may be applied to stationary or mobile devices utilizing any portion of the electromagnetic spectrum and a signaling standard (such as the IEEE 802 family of standards, GSM/CDMA/TDMA or other cellular standard, and/or the ISM band). The services 20/44, however, may be applied to a processor-controlled device operating in the radio-frequency domain and/or the Internet Protocol (IP) domain. The services 20/44 may be applied to a processor-controlled device utilizing a distributed computing network, such as the Internet (sometimes alternatively known as the “World Wide Web”), an intranet, a local-area network (LAN), and/or a wide-area network (WAN). The services 20/44 may be applied to a processor-controlled device utilizing power line technologies, in which signals are communicated via electrical wiring. Indeed, the many examples may be applied regardless of physical componentry, physical configuration, or communications standard(s).

The services 20/44 may utilize a processing component, configuration, or system. For example, the services 20/44 may be easily adapted to a desktop, mobile, or server central processing unit or chipset offered by INTEL®, ADVANCED MICRO DEVICES®, ARM®, APPLE®, TAIWAN SEMICONDUCTOR MANUFACTURING®, QUALCOMM®, or other manufacturer. The services 20/44 may even use multiple central processing units or chipsets, which could include distributed processors or parallel processors in a single machine or multiple machines. The central processing unit or chipset can be used in supporting a virtual processing environment. The central processing unit or chipset could include a state machine or logic controller. When any of the central processing units or chipsets execute instructions to perform “operations,” this could include the central processing unit or chipset performing the operations directly and/or facilitating, directing, or cooperating with another device or component to perform the operations.

The services 20/44 may be applied regardless of the operating system. The services 20/44 may be applied or adapted to processor-controlled devices executing the MICROSOFT® operating system (such as a version of the WINDOWS® and WINDOWS SERVER® operating systems). The services 20/44 may be applied or adapted to processor-controlled devices executing the APPLE® operating systems (such as a version of the MACOS®, IOS®, and OS® operating systems). The services 20/44 may be applied or adapted to processor-controlled devices executing a version of the LINUX®, ANDROID®, CHROMEOS®, UNIX®, and other operating systems.

The services 20/44 may use packetized communications. When the computer system 22 communicates via communications networks, information may be collected, sent, and retrieved. The information may be formatted or generated as packets of data according to a packet protocol (such as the Internet Protocol). The packets of data contain bits or bytes of data describing the contents, or payload, of a message. A header of each packet of data may be read or inspected and contain routing information identifying an origination address and/or a destination address.

The services 20/44 may utilize a signaling standard. The computer system 22 and/or the cloud computing environment 24 may mostly use wired networks to interconnect network members. However, the computer system 22 and/or the cloud computing environment 24 may utilize other communications devices using the Global System for Mobile (GSM) communications signaling standard, the Time Division Multiple Access (TDMA) signaling standard, the Code Division Multiple Access (CDMA) signaling standard, the “dual-mode” GSM-ANSI Interoperability Team (GAIT) signaling standard, or a variant of the GSM/CDMA/TDMA signaling standard. The services 20/44 may also utilize other standards, such as the I.E.E.E. 802 family of standards, the Industrial, Scientific, and Medical band of the electromagnetic spectrum, BLUETOOTH®, low-power or near-field, and other standard or value.

The services 20/44 may be physically embodied on or in a computer-readable storage medium. This computer-readable medium, for example, may include CD-ROM, DVD, tape, cassette, floppy disk, optical disk, USB flash memory drive, memory card, memory drive, and large-capacity disks. This computer-readable medium, or media, could be distributed to end-subscribers, licensees, and assignees. A computer program product comprises processor-executable instructions for parsing the log data 30, as the above paragraphs explain.

The diagrams, schematics, illustrations, and the like represent conceptual views or processes illustrating examples of parsing the log data 30. The functions of the various elements shown in the figures may be provided through the use of dedicated hardware as well as hardware capable of executing instructions. The hardware, processes, methods, and/or operating systems described herein are for illustrative purposes and, thus, are not intended to be limited to a particular named manufacturer or service provider.

As used herein, the singular forms “a,” “an,” and “the” are intended to include the plural forms as well, unless expressly stated otherwise. It will be further understood that the terms “includes,” “comprises,” “including,” and/or “comprising,” when used in this Specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

It will also be understood that, although the terms first, second, and so on, may be used herein to describe various elements, these elements should not be limited by these terms. These terms are only used to distinguish one element from another. For example, a first computer or container could be termed a second computer or container and, similarly, a second device could be termed a first device without departing from the teachings of the disclosure.

1. A method that parses a log data, comprising:
generating, by a computer system providing a log management service, multiple log parser candidates associated with at least one large language model, each log parser candidate of the multiple log parser candidates parsing a sample of the log data using the at least one large language model;
generating a log parser decision that selects a log parser candidate of the multiple log parser candidates; and
in response to the log parser decision, parsing the log data using the at least one large language model that corresponds to the log parser decision that selected the log parser candidate of the multiple log parser candidates.

2. The method of claim 1, further comprising evaluating the each log parser candidate of the multiple log parser candidates.

3. The method of claim 1, further comprising compiling the log parser candidate of the multiple log parser candidates.

4. The method of claim 1, further comprising determining a sample event using the log parser candidate of the multiple log parser candidates.

5. The method of claim 1, further comprising incorporating the at least one large language model in the log management service.

6. The method of claim 1, further comprising receiving the sample of the log data.

7. A computer system that parses a log data, comprising:
at least one central processing unit; and
at least one memory device storing instructions that, when executed by the at least one central processing unit, perform operations, the operations comprising:
generating, by a log management service, multiple log parser candidates using at least one large language model, each log parser candidate of the multiple log parser candidates parsing a sample of the log data using the at least one large language model;
executing, by the log management service, a preliminary parsing model test that compares the multiple log parser candidates to at least one parsing criterion;
generating, by the log management service, a log parser decision that selects a log parser candidate from the multiple log parser candidates based on the preliminary parsing model test; and
in response to the log parser decision, parsing, by the log management service, the log data using the at least one large language model that corresponds to the log parser decision that selected the log parser candidate from the multiple log parser candidates based on the preliminary parsing model test.

8. The computer system of claim 7, wherein the operations further comprise compiling the log parser candidate of the multiple log parser candidates.

9. The computer system of claim 8, wherein the operations further comprise determining a compiling error associated with the compiling of the log parser candidate.

10. The computer system of claim 9, wherein in response to the compiling error associated with the compiling of the log parser candidate, the operations further comprise rejecting, by the log management service, the log parser candidate as a log parser.

11. The computer system of claim 9, wherein in response to the compiling error associated with the compiling of the log parser candidate, the operations further comprise refining a model input associated with the log parser candidate.

12. The computer system of claim 8, wherein the operations further comprise determining the log parser candidate successfully compiled.

13. The computer system of claim 12, wherein in response to the determining that the log parser candidate successfully compiled, the operations further comprise generating a sample event by parsing the sample of the log data using the log parser candidate that successfully compiled.

14. The computer system of claim 13, wherein the operations further comprise determining a log parser eligibility associated with the log parser candidate based on the sample event generated by the parsing of the sample of the log data using the log parser candidate that successfully compiled.

15. The computer system of claim 13, wherein the operations further comprise rejecting, by the log management service, the log parser candidate as a log parser based on the sample event.

16. The computer system of claim 13, wherein the operations further comprise approving, by the log management service, the log parser candidate as a log parser based on the sample event.

17. The computer system of claim 13, wherein the operations further comprise determining a parsing error associated with the sample event generated by the parsing of the sample of the log data using the log parser candidate that successfully compiled.

18. The computer system of claim 17, wherein in response to the parsing error associated with the sample event, the operations further comprise rejecting, by the log management service, the log parser candidate as a log parser.

19. The computer system of claim 17, wherein in response to the parsing error associated with the sample event, the operations further comprise refining a model input associated with the log parser candidate.

20. A memory device storing instructions that, when executed by at least one central processing unit, perform operations, comprising:
generating, by a log management service, multiple log parser candidates associated with at least one large language model, each log parser candidate of the multiple log parser candidates parsing a sample of the log data using the at least one large language model;
generating, by the log management service, sample events by parsing the sample of the log data using the each log parser candidate;
comparing, by the log management service, the sample events generated by the parsing the sample of the log data using the each log parser candidate to a log parsing profile generated by a machine learning model trained to represent parsed events;
generating, by the log management service, a log parser prediction based on the comparing of the each log parser candidate to the log parsing profile generated by the machine learning model trained to represent the parsed events;
generating, by the log management service, a log parser decision that selects a log parser candidate from the multiple log parser candidates based on the log parser prediction; and
in response to the log parser decision, parsing, by the log management service, the log data using the log parser candidate that corresponds to the log parser decision.
